(19) United States
(12) Patent Application Publication
(10) Pub. No.: US 2010/0004143 A1
(43) Pub. Date: Jan. 7, 2010

(54) PROBE-ARRAY SUBSTRATE, PROBE ARRAY, AND METHOD OF PRODUCING THE SAME

(75) Inventor: TERUHISA SHIBAHARA, Tokyo-to (JP)

Correspondence Address: DICKSTEIN SHAPIRO LLP, 1633 Broadway, NEW YORK, NY, 10019, US

(73) Assignee: Murata Manufacturing Co., Ltd., Nagaokakyo-shi (JP)

(21) Appl. No.: 12/493,624

(22) Filed: Jun. 29, 2009

(30) Foreign Application Priority Data
Jul. 7, 2008 (JP) 2008-178716

(51) Int. Cl. C40B 40/06; C40B 50/18

(52) U.S. Cl. 506/16; 506/32

(57) ABSTRACT

A probe-array substrate includes a plurality of probe holding units each having a projection that exhibits a hydrophilicity and a hydrophobic region disposed so as to surround each of the probe holding units. The probe-array substrate can further include an inspection region for use in checking whether mixture of probe solutions is present among the plurality of probe holding units. The inspection region is disposed between the neighboring probe holding units across the hydrophobic region.

### BACKGROUND OF THE INVENTION

1. Field of the Invention

The present invention relates to a probe-array substrate for use in a chemical or biochemical field, a probe array constructed using a probe-array substrate, and a method of producing the same.

2. Description of the Related Art

DNA chips have captured much attention as a tool for performing a genetic diagnosis for multiple items at a time, examining the amount of expression of various types of mRNA at a time, or examining single nucleotide polymorphisms (SNPs) for multiple items at a time. The DNA chip, also called a DNA microarray, is a probe array that uses a known DNA causing hybridization with a target DNA or RNA molecule as a probe and that includes different types of probes in a plurality of probe holding units arranged at regular intervals.

Antigen or antibody chips have captured attention as a tool for examining the presence or absence of multiple types of antigens or antibodies at the same time. These chips are a probe array that utilize the known antigen coupling (binding) to an antibody and that includes different types of probes in a plurality of probe holding units arranged at regular intervals.

One typical method of producing a probe array is a method of arranging spots on the surface of a substrate by applying a probe solution (i.e. a solution containing a probe molecule) on the substrate, such as a slide glass, in dot form (hereinafter referred to as spotting) and chemically binding probe molecules to the surface of the board. Known methods include, for example, a method of discharging a probe solution onto the substrate using an injection needle, micropipette, or ink jetting and a method of bringing a probe solution attached on a needle point into contact with the substrate.

An exemplary micropipette for use in practicing the above-described method utilizing spotting is the micropipette used in densely arranging droplets having small volume for use. One such micropipette is disclosed in Japanese Unexamined Patent Application Publication No. 2004-45055. One example of a method of efficiently arranging droplets supplied from a micropipette on an array substrate that has a structure preventing contamination of the droplets is disclosed in Japanese Unexamined Patent Application Publication No. 2004-4076.

In spotting, as previously described, it is necessary to arrange different types of probe solutions on a substrate. If an injection needle, micropipette, or ink jetting is used in spotting, it is necessary to change the solution for every one-point application, and this sacrifices cost or production speed. To address this, it is desired that different types of probe solutions be applied in one spotting.

If droplets of probe solutions in neighboring spots during spotting come into contact with each other, the droplets are mixed and the substrate is defective as a probe array. It is desired that such a defect occurs less often. In addition, when such a defect is encountered, it is desired to be able to easily and reliably detect the defective.

### SUMMARY OF THE INVENTION

Accordingly, it is an object of the present invention to provide a probe-array substrate, a probe array constructed using the probe-array substrate, and a method of producing the same that can satisfy the above-described requirements.

Preferred embodiments of the present invention are first directed to a probe-array substrate including a main surface and a plurality of probe holding units arranged along the main surface. To solve the above-described technical problems, the probe-array substrate further includes a low wettability region disposed so as to virtually surround each of the plurality of probe holding units, the low wettability region exhibiting relatively low wettability with respect to a probe solution, and the probe holding unit includes a projection that exhibits relatively high wettability with respect to the probe solution.

The terms “relatively high wettability” and “relatively low wettability” indicate wettability as indicated by the angle between a free surface of a liquid and a surface of a solid with which the surface of the liquid is in contact. Relatively high wettability means angle of contact (wetting angle) is equal to or less than 90° and relatively low wettability means angle of contact (wetting angle) exceeds 90°, respectively. Accordingly, when the probe solution is an aqueous solution, “relatively high wettability” generally means hydrophilic, and “relatively low wettability” means hydrophobic.

The projection may project from the low wettability region, and the probe holding unit may be provided by the projection alone. Preferably, the probe-array substrate may further include a high wettability region disposed around the projection on the main surface, the high wettability region exhibiting relatively high wettability with respect to the probe solution, and the probe holding unit may be provided by the projection and the high wettability region.

The probe holding unit may have a recessed shape from the main surface.

The probe-array substrate may further include an inspection region for use in checking whether a mixture of probe solutions is present among the plurality of probe holding units, the inspection region exhibiting relatively high wettability with respect to each of the probe solutions. The low wettability region may be disposed between the inspection region and each of neighboring probe holding units of the plurality of probe holding units.

The projection may preferably have a guide groove for facilitating an introduction of the probe solution into the probe holding unit.

According to another aspect of the preferred embodiments of the present invention, a probe-array substrate has no projections. Each of a plurality of probe holding units is provided by a region that exhibits relatively high wettability with respect to a probe solution. The probe-array substrate further includes a low wettability region disposed so as to virtually surround each of the plurality of probe holding units, the low wettability region exhibiting relatively low wettability with respect to a probe solution and an inspection region for use in checking whether a mixture of probe solutions is present among the plurality of probe holding units, the inspection region exhibiting relatively high wettability with respect to each of the probe solutions. The low wettability region is disposed between the inspection region and each of neighboring probe holding units of the plurality of probe holding units.

When the probe solution is an aqueous solution, the relatively high wettability reflects an affinity for water and the relatively low wettability does not have an affinity for water, the probe-array substrate may preferably be made of a hydrophilic material, and the low wettability region may preferably be provided by a photosensitive resin film formed by patterning on the surface of the probe-array substrate using photolithography.

When the probe solution is an aqueous solution, the probe-array substrate may preferably be made of a hydrophilic material, and the main surface may preferably include a resin film formed thereon. The probe holding unit may preferably be disposed in a portion from which the resin film is removed by plasma ashing after the formation of the resin film. The low wettability region may preferably be provided by the resin film remaining after the removal using plasma ashing.

Each of the plurality of probe holding units may include a wall that virtually surrounds the projection. The probe-array substrate may include a groove section to which a resin is applied, the groove section being disposed between neighboring walls. The low wettability region may be provided by the surface of the resin remaining after plasma ashing performed such that the resin within the groove section is not eliminated. At least part of the high wettability region may be provided by a portion from which an unnecessary segment of the resin is removed by the plasma ashing.

The preferred embodiments of the present invention are also directed to a probe array including a probe-array substrate according to at least one of the above-described preferred embodiments of the present invention and a probe molecule retained in each of the plurality of probe holding units of the probe-array substrate.

The preferred embodiments of the present invention are also directed to a method of producing a probe array using a probe-array substrate according to at least one of the preferred embodiments of the present invention.

The method of producing a probe array according to at least one of the preferred embodiments of the present invention includes preparing a probe-array substrate according to at least one of the preferred embodiments of the present invention, preparing a supplying unit that has nozzles arranged so as to correspond to the projections, each of the nozzles being filled with a probe solution, and bringing the nozzle of the supplying unit near to the corresponding projection, causing the probe solution and the projection to come into contact with each other, and thus guiding the probe solution into the probe holding unit.

In the above-described method of producing a probe array, I≦D/2 is preferably true, where I is the distance from a center of each of the projections to the low wettability region and D is the outer diameter of each of the nozzles.

Alternatively, in the above-described method of producing a probe array, N>D×[arccosh {(2I/D)×cosh (ψ)}−ψ]/[2×cosh (ψ)] is preferably be true when I>D/2, where I is a distance from a center of each of the projections to the low wettability region, D is the outer diameter of each of the nozzles, N is the length of the nozzle, and ψ is defined by ψ=arcsinh (tan θ3), where θ3 is a wetting angle between an outer area of the nozzle and the probe solution.

In performing the method of producing a probe array according to at least one of the preferred embodiments, when the probe-array substrate is prepared in which the high wettability region, which exhibits relatively high wettability with respect to the probe solution, is formed around the projection on the main surface and the probe holding unit is provided by the projection and the high wettability region, it is preferable that I<[D×cosh {arcsinh (1/tan θ2)}]/[2×cosh {arcsinh (tan θ3)}], where D is the outer diameter of the nozzle, I is the distance from a center of the projection to the low wettability region, θ2 is a wetting angle between the high wettability region adjacent to the probe holding unit in the probe-array substrate and the probe solution, and θ3 is a wetting angle between an outer area of the nozzle and the probe solution.

In performing the method of producing a probe array according to at least one of the preferred embodiments, when the probe-array substrate in which the inspection portion is formed is prepared, it is preferable that after the step of guiding the probe solution into the probe holding unit, the step of determining that the probe solution is not attached in the inspection region is preferably performed.

With the probe-array substrate according to at least one of the embodiments of the present invention, relatively high wettability is provided in the probe holding unit, and the low wettability region, which exhibits relatively low wettability, is disposed so as to substantially surround each of the probe holding unit. Therefore, the probe solution can be smoothly introduced in the probe holding unit, and is reliably prevented by the low wettability region from wetting and spreading out on the main surface. Accordingly, the density of probes in a probe array can be increased.

When the probe holding unit of the probe-array substrate according to at least one of the embodiments of the present invention includes a projection that exhibits relatively high wettability, the wetting force acting between the probe solution and the projection enables the introduction of the probe solution into the probe holding unit more smoothly.

When the probe-array substrate according to at least one of the embodiments of the present invention includes the inspection region, the occurrence of a defect caused by mixture (cross-contamination) of droplets of neighboring probe solutions can be reliably detected by, after the probe solution is introduced into the probe holding unit of the probe-array substrate, checking whether the inspection region is wet or whether there is an indication of drying after wetting.

With the method of producing a probe array according to at least one of the embodiments of the present invention, many different types of probe solutions can be supplied from the supplying unit to the probe-array substrate at a single time. Therefore, the probe array can be produced efficiently at low cost. In filling the plurality of nozzles of the supplying unit with the probe solutions, it is necessary to fill the plurality of nozzles with different types of the probe solutions. This operation can be relatively time consuming and costly. However, because the probe solutions can be supplied to many probe-array substrates using a supplying unit and the probe solutions once inserted are retained, the operation is not time consuming and costly.

With the method of producing a probe array according to at least one of the embodiments of the present invention, the projection, which exhibits relatively high wettability, of the probe holding unit and the nozzle containing the probe solution are brought near to each other are caused to come into contact with each other to guide the probe solution into the probe holding unit. Accordingly, a capillary phenomenon and wetting force acting between the probe solution and the projection enables the probe solution to be introduced into the probe holding unit smoothly and reliably.

Other features, elements, characteristics and advantages of the present invention will become more apparent from the following detailed description of preferred embodiments of the present invention (with reference to the attached drawings).

### BRIEF DESCRIPTION OF THE DRAWINGS

FIG. 1 is a perspective view that illustrates in part a probe-array substrate according to a first embodiment of the present invention;

FIG. 2 is a top view that illustrates in part the probe-array substrate shown in FIG. 1;

FIGS. 3A, 3B, 3C, and 3D are cross-sectional views that illustrate a process performed to produce the probe-array substrate shown in FIG. 1;

FIG. 4 is a cross-sectional view that illustrates a supplying unit advantageously used in combination with the probe-array substrate to produce a probe array using the probe-array substrate;

FIGS. 5A, 5B, 5C, 5D, 5E, and 5F are end views for describing a process performed to produce the supplying unit shown in FIG. 4 and illustrate the supplying unit at a specific end section;

FIGS. 6A, 6B, and 6C are cross-sectional views that illustrate a process performed to produce a probe-array using the probe-array substrate shown in FIG. 1 and the supplying unit shown in FIG. 4;

FIG. 7 is an illustration for use in describing a state in which a solid cylinder is inserted substantially perpendicular to the liquid level;

FIG. 8 is an illustration for use in describing how a probe aqueous solution guided to a hydrophilic region of a probe holding unit sufficiently wets and spreads out on the hydrophilic region;

FIG. 9 is an illustration for use in describing how probe aqueous solution that covers the whole area of the hydrophilic region of the probe holding unit wets up on the outer areas of a nozzle when the relationship I≦D/2 is true;

FIG. 10 is an illustration for use in describing how probe aqueous solution that covers the whole area of the hydrophilic region of the probe holding unit wets up on the outer areas of a nozzle when the relationship I>D/2 is true;

FIG. 11 is an illustration for use in describing a second embodiment of the present invention and corresponds to FIG. 2;

FIG. 12 is an illustration for use in describing a third embodiment of the present invention and corresponds to FIG. 1; and

FIG. 13 is an illustration for use in describing a fourth embodiment of the present invention and corresponds to FIG. 1.

### DESCRIPTION OF THE PREFERRED EMBODIMENTS

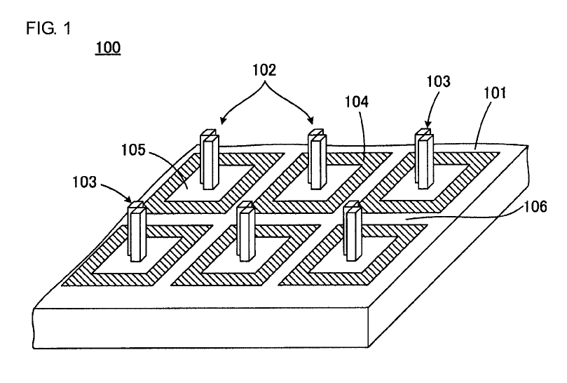

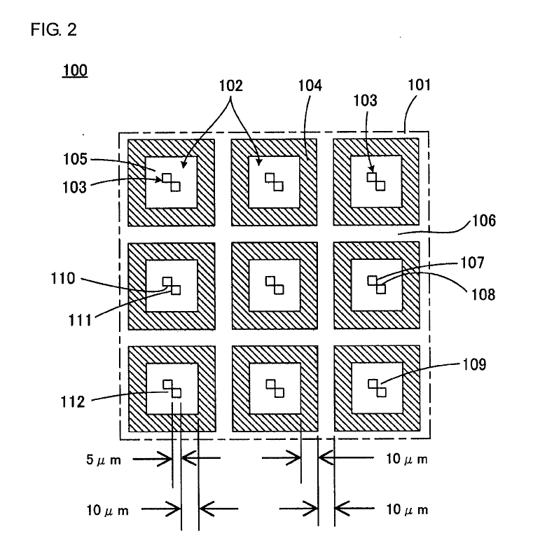

FIG. 1 illustrates in part of a probe-array substrate 100 according to a first embodiment of the present invention in perspective view. FIG. 2 is a top view of a part of the probe-array substrate 100 shown in FIG. 1.

Referring to FIGS. 1 and 2, the probe-array substrate 100 includes a main surface 101 and is substantially planar as a whole. A plurality of probe holding units 102 are arranged in a matrix on the probe-array substrate 100.

Each of the probe holding units 102 includes a hydrophilic projection 103. The terms “hydrophilic” and “hydrophobic” are usually used as terms indicating the presence or absence of wettability (affinity) for water. In the following description, however, regardless of whether a probe solution is an aqueous solution, when wettability for a probe solution is high, the state is represented as “hydrophilic,” and when wettability therefor is low, the state is represented as “hydrophobic.”

Each of the probe holding units 102 is surrounded by a hydrophobic region 104 on the main surface 101 of the probe-array substrate 100. In the present embodiment, a hydrophilic region 105 having a substantially square shape is disposed around the hydrophilic projection 103 on the main surface 101. Accordingly, the probe holding unit 102 is provided by the above-described projection 103 and the hydrophilic region 105. Therefore, a sufficient amount of a probe solution can be held in each of the probe holding units 102, and this leads to a reduction in unevenness of the amounts of probe solutions held in the probe holding units 102.

In addition, a hydrophilic inspection region 106 for use in checking whether mixture (cross-contamination) of probe solutions is present is disposed on the main surface 101 of the probe-array substrate 100. The inspection region 106 is disposed between neighboring probe holding units 102. The hydrophobic region 104 disposed between the inspection region 106 and each of the probe holding units 102. The inspection region 106 can have a grid shape, for example. After probe solutions are introduced into the probe holding units 102, it can be determined whether the inspection region 106 is wet or whether there is an indication of being dried after being wet. Therefore, the occurrence of a defect caused by cross-contamination of droplets of neighboring probe solutions can be reliably detected with the use of the inspection region 106.

The above-described projection 103 has a shape in which two substantially square poles are arranged in a diagonal direction such that a single edge line of one of the two substantially square poles is in contact with a single edge line of the other. As illustrated in FIG. 2, the length of the side of the substantially square defining a cross section of each of the substantially square poles can be approximately 5 μm, for example. The distance between the projection 103 and the hydrophobic region 104 can be approximately 10 μm, for example. The width of the inspection region 106 can be approximately 10 μm, for example. In addition, the height of the projection 103 can be approximately 100 μm, for example. The arrangement pitch of the neighboring projections 103 can be approximately 60 μm, for example.

In the projection 103 having the above-described shape, a guide groove 109 defined by surfaces 107 and 108 and a guide groove 112 defined by surfaces 110 and 111 are opposed to each other in a diagonal line direction. Each of the guide grooves 109 and 112 has a substantially L-shaped cross section. The functions of each of the projection 103 and the guide grooves 109 and 112 will be described later.

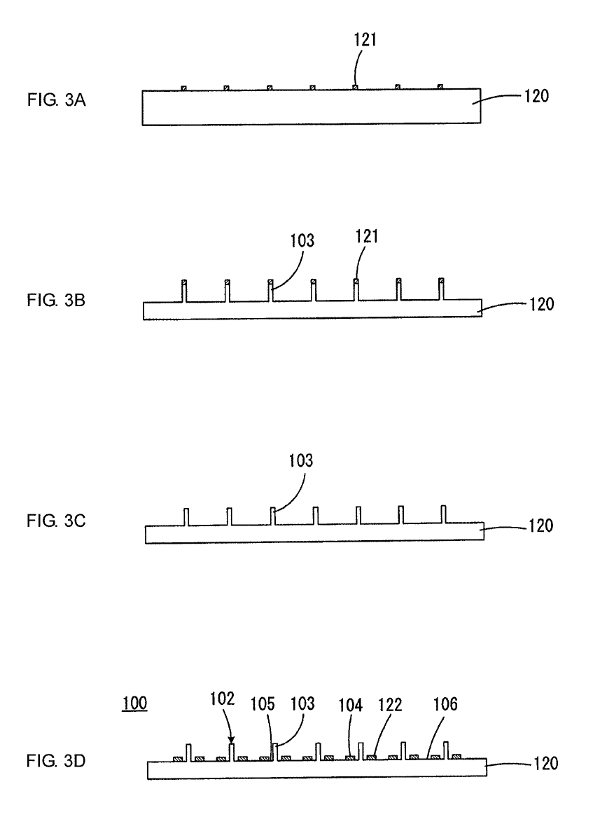

A method for producing the probe-array substrate 100 is described, next. FIGS. 3A to 3D illustrate a typical process performed to produce the probe-array substrate 100.

First, as illustrated in FIG. 3A, a material board 120 to become the probe-array substrate 100 is prepared. The material board 120 can be formed from a monocrystalline silicon substrate having a thickness of approximately 500 μm, for example.

Then, as illustrated in the same FIG. 3A, a resist pattern 121 is formed on the surface of the material board 120 using photolithography. When the resist pattern 121 is described with reference to the probe-array substrate 100 illustrated in FIG. 2, the resist pattern 121 is formed so as to cover the portion to become the projection 103.

Then, as illustrated in FIG. 3(B), the material board 120 is dry-etched with a depth of, for example, approximately 100 μm while the resist pattern 121 is used as a mask. For the dry-etching, the inductively coupled plasma reactive ion etching (ICP-RIE) technology is advantageously applied, and etching using a gas plasma containing atoms of fluorine, such as carbon tetrafluoride, or sulfur hexafluoride is performed. Upon the completion of this step, the shape of the projection 103 is provided to the material board 120.

Then, as illustrated in FIG. 3C, the resist pattern 121 and organic contaminants on the surface are removed by cleaning using a mixed solution of sulfuric acid and hydrogen peroxide.

Then, as illustrated in FIG. 3D, a photosensitive resin film 122 patterned so as to provide the previously described hydrophobic region 104 is formed. In FIG. 3D, the thickness of the photosensitive resin film 122 is exaggerated. A process performed to form the patterned photosensitive resin film 122 is described below.

First, after the structure illustrated in FIG. 3C is acquired, a photosensitive resin (e.g., photosensitive polyimide) is applied over the entire surface of that structure.

Then, ultraviolet irradiation is performed by, for example, a stepper using an appropriate photomask. When the negative photosensitive resin is used, the photomask has a pattern that shields the portions to become the projection 103, the hydrophilic region 105, and the inspection region 106 from light and that allows light to reach the portion to become the hydrophobic region 104.

When development is performed after the ultraviolet irradiation, the photosensitive resin is patterned, and as illustrated in FIG. 3D, the photosensitive resin film 122 to provide the hydrophobic region 104 is formed.

After that, plasma ashing is performed such that the photosensitive resin film 122 is not eliminated. This removes resin slightly attached to a portion at which the photosensitive resin film 122 should not remain (e.g., a portion to become the projection 103, the hydrophilic region 105, or the inspection region 106). When the material board 120 is made of silicon, as described above, because oxygen plasma is used in plasma ashing, the uppermost surface of silicon is oxidized. This leads to satisfactory hydrophilicity in the projection 103, the hydrophilic region 105, and the inspection region 106.

In such a way, the probe-array substrate 100 is acquired.

The hydrophobic region 104 may not be provided by the photosensitive resin film 122 formed by patterning using photolithography, as described above, but may be provided by a simple resin film. In this case, the projection 103 and the hydrophilic region 105, which are to become the probe holding unit 102, and the inspection region 106 may be exposed by removal of the simple resin film by plasma ashing.

With the above-described method of producing the probe-array substrate 100, the projection 103 is formed by dry-etching of the material board 120 made of monocrystalline silicon. The use of this method enables the fine and high-aspect projection 103 to be produced by performing an etching process once. The term “high-aspect” indicates that the depth of etching is larger than the width of the opening. It is possible for dry-etching of the material board 120 made of monocrystalline silicon to achieve processing with an aspect ratio of no less than 20. As an alternative to such a method using dry-etching, a method using wet-etching, which is less expensive, may also be used.

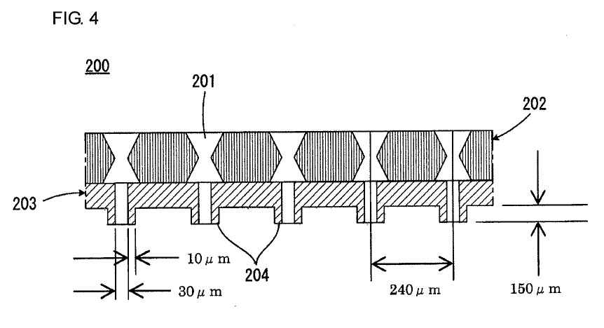

In producing a probe array constructed using the above-described probe-array substrate 100, more specifically, a DNA chip in which different types of probe DNAs are arranged, a supplying unit 200 illustrated in FIG. 4 is used.

The supplying unit 200 includes a glass portion 202 and a finely patterned silicon portion 203. The glass portion 202 has a plurality of through-holes 201 formed with a pitch of, for example, approximately 240 μm and has a thickness of, for example, approximately 400 μm. The silicon portion 203 has a nozzle 204 linking with each of the through-holes 201 formed in the glass portion 202. The inner diameter of the nozzle 204 can be approximately 30 μm, for example. The thickness of the nozzle 204 can be approximately 10 μm, for example. The outer diameter of the nozzle 204 can be approximately 50 μm, for example. The length of the nozzle 204 can be approximately 150 μm, for example.

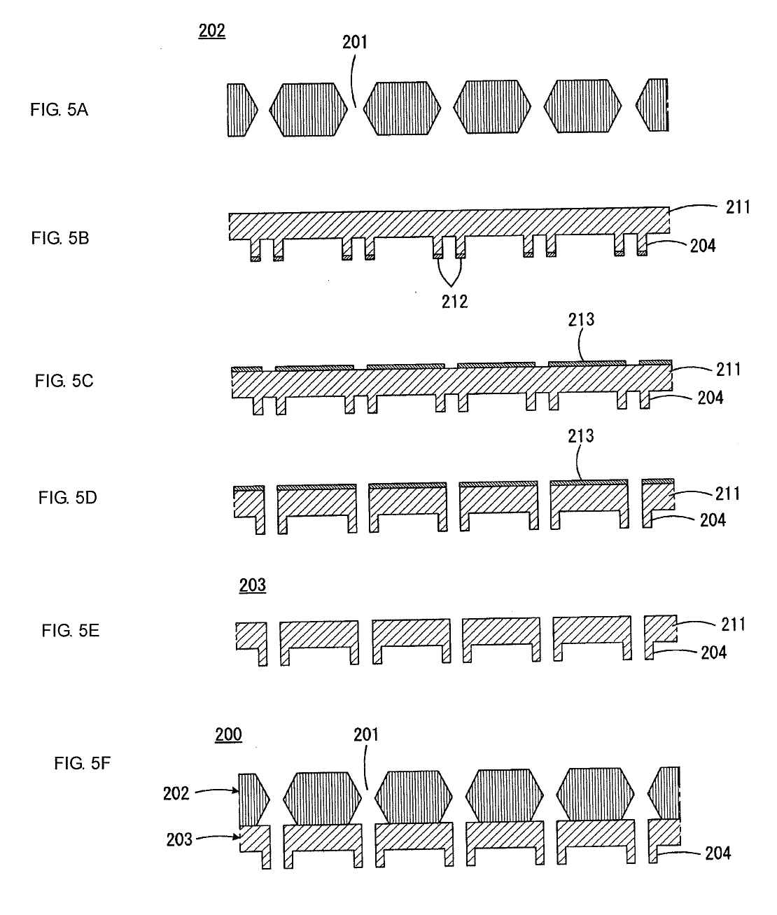

One example method of producing the supplying unit 200 is described next with reference to FIGS. 5A, 5B, 5C, 5D, 5E, and 5F, which are end views of the supplying unit 200 at a specific end section. First, prepared is a 400 μm thick glass wafer, for example, which has planar polished surfaces at both sides. A resist pattern mask in applied by photolithography. Through-holes 201 are made by sandblasting to obtain the glass portion 202 for supplying unit as illustrated in FIG. 5A. Alternatively, first performing processing to a depth that exceeds half the overall depth of the hole from one surface of the glass wafer and then performing processing from an opposite surface may result in each of the through-holes 201.

As illustrated in FIG. 5B, a resist pattern 212 is formed by photolithography on a first main surface of a silicon wafer 211 that has a thickness of, for example, approximately 350 μm and that has both surfaces subjected to planar polishing. The silicon wafer 211 is etched by ICP-RIE while the resist pattern 212 is used as a mask to recess it by a depth of the order of, for example, approximately 150 μm. This produces part of the nozzle 204 in the silicon portion 203.

Then, as illustrated in FIG. 5C, the resist pattern 212 formed on the silicon wafer 211 is removed using a mixed solution of sulfuric acid and hydrogen peroxide, and a resist pattern 213 is formed in a similar way to that for the resist pattern 212 on a second main surface opposite to the first main surface on which the resist pattern 212 was formed.

Then, as illustrated in FIG. 5D, the silicon wafer 211 is etched by ICP-RIE while the resist pattern 213 is used as a mask, so that the nozzle 204 extends through the silicon wafer 211.

Then, as illustrated in FIG. 5E, the resist pattern 213 formed on the silicon wafer 211 is removed using a mixed solution of sulfuric acid and hydrogen peroxide. This produces the silicon portion 203 for the supplying unit 200.

Then, as illustrated in FIG. 5F, in a state where the nozzle 204 of the silicon portion 203 and the through-hole 201 of the glass portion 202 are aligned, the silicon portion 203 and the glass portion 202 are bonded by anodic bonding. Anodic bonding is a technique for bonding silicon and glass by stacking silicon and glass, heating the stack to the order of approximately 300° C. to 500° C., and applying a direct-current voltage of several hundred volts in which silicon is the anode and glass is the cathode. The performance of anodic bonding couples atoms at the uppermost surface of silicon and atoms at the uppermost surface of glass and enables airtight bonding.

In such a way, the supplying unit 200 can be produced.

A method of producing a probe array using the above-described supplying unit 200, more specifically, a method of producing a DNA chip in which different types of probe DNA are arranged is described next.

In the case where the probe-array substrate 100 is constructed using silicon, a silicon oxide film is formed on the portions where silicon is exposed in the probe-array substrate 100, that is, the probe holding unit 102, which is composed of the projection 103 and the hydrophilic region 105, and the inspection region 106. By application of an aminosilane to the silicon oxide film, an amino group is introduced into the silicon surface. After that, by application of a reagent containing N-(6-maleimidocaproyloxy)succinimide, the amino group at the uppermost surface of the probe-array substrate 100 is substituted with a maleimide group.

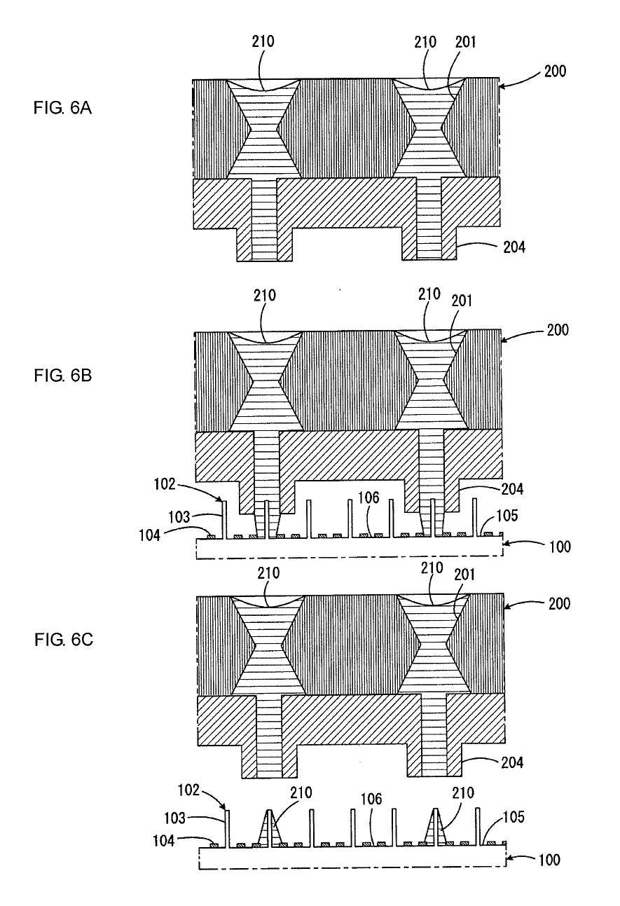

The supplying unit 200 is prepared, and each of the through-holes 201 in the supplying unit 200 are filled with a probe aqueous solution 210, as illustrated in FIG. 6A. In this filling, a micropipette or ink jetting is used. Different types of the probe aqueous solutions 210 are prepared and are inserted in the different through-holes 201. As a probe DNA contained in each of the probe aqueous solutions 210, one in which a thiol group is added to the 5′-terminus is used in this embodiment. Because the inner diameter of each of the through-hole 201 and the silicon portion 203 is sufficient small, the probe aqueous solution 210 in each of the through-holes 201 quickly reaches the tip of the nozzle 204 by capillary action, and the surface tension prevents the probe aqueous solution 210 from spontaneously flowing out of the nozzle 204.

To prevent the probe DNA from being attracted to the surface of the supplying unit 200 and the density of the probe aqueous solution 210 from decreasing, the supplying unit 200 may be rinsed with the probe aqueous solution 210 one or more times. Alternatively, before the probe aqueous solution 210 is inserted into each of the through-holes 201, the supplying unit 200 may be washed with an aqueous solution of bovine serum albumin (BSA) or an appropriate DNA fragment to block the surface of the supplying unit 200.

Then, the probe-array substrate 100 and the supplying unit 200 placed in proper alignment are brought nearer to each other. As a result, each of the probe aqueous solutions 210 positioned in the openings of the nozzles 204 comes into contact with the projection 103 on the probe-array substrate 100. At this time, as one example, when the tip of the nozzle 204 and the main surface 101 of the probe-array substrate 100 are brought nearer such that the distance therebetween is the order of approximately 80 μm, the projection 103 has been inserted into the nozzle 204 by approximately 20 μm, so the probe aqueous solution 210 and the projection 103 are in contact with each other with reliability.

When the probe aqueous solution 210 and the projection 103 come into contact with each other, as described above, the wetting force acting between the probe aqueous solution and the probe holding unit 102 of the probe-array substrate 100 causes the probe aqueous solution 210 to wet the projection 103 and spread out on the hydrophilic region until the probe aqueous solution 210 is stopped by the hydrophobic region 104. In such a way, as illustrated in FIG. 6B, the probe aqueous solution 210 is introduced in each of the probe holding unit 102. The detailed mechanism of action will be described later.

Then, when the supplying unit 200 is separated from the probe-array substrate 100 after a predetermined period of time elapses, as illustrated in FIG. 6C, a state is obtained in which the probe aqueous solution 210 is attached to the probe holding unit 102, which includes the projection 103, of the probe-array substrate 100.

When the projections 103 are disposed with a pitch of approximately 60 μm on the probe-array substrate 100 and the nozzles 204 are disposed with a pitch of approximately 240 μm in the supplying unit 200, the probe aqueous solution 210 cannot be attached to some of the probe holding units 102 of the probe-array substrate 100. However, if four supplying units 200 having different types of the probe aqueous solutions 210 therein are prepared and the probe aqueous solutions 210 are sequentially introduced to the probe-array substrate 100, the different probe aqueous solutions 210 can be provided to all of the probe holding units 102.

When the probe aqueous solution 210 attached to each of the probe holding units 102 of the probe-array substrate 100 is set aside for a certain period of time, the maleimide group coupled to the silicon surface exposed to the probe holding unit 102 and the thiol group introduced in probe DNA molecules are chemically bound to each other. As a result, a state is obtained in which probe DNA molecules to become a probe are retained in the probe holding unit 102 of the probe-array substrate 100.

When the probe holding unit is rinsed with water and dried it, the DNA chip is completed.

In the above embodiment, binding of the maleimide group and thiol group is used in binding of probe DNA molecules and the probe-array substrate 100. However, other types of binding, such as avidin-biotin binding, may also be used.

The probe DNA aqueous solution may be attached to the probe-array substrate 100 using a simple nozzle (capillary tube) without use of the supplying unit 200. However, with this method, the nozzle must be aligned and brought into close position each time for all the probe holding units 102 on the probe-array substrate 100, so it is time consuming and costly. Therefore, as illustrated in FIGS. 6A to 6C, it may be preferable that the supplying unit 200 having a plurality of nozzles be used.

In filling a plurality of nozzles 204 of the supplying unit 200 with different probe aqueous solutions 210, it is necessary to fill the plurality of nozzles 204 with the different types of the probe aqueous solutions 210. This operation can be relatively time consuming and costly. However, because the probe aqueous solutions 210 can be supplied to many probe-array substrates 100 using the supplying unit 200 retaining the probe aqueous solutions 210 once inserted, in terms of a single probe array, the operation is not time consuming and costly.

In a step of transferring the probe aqueous solution 210 to the probe-array substrate 100 illustrated in FIG. 6B, if a probe aqueous solution 210 reaches an adjacent probe holding unit 102, mixture (cross-contamination) of probe aqueous solutions 210 occurs between the probe holding units 102. This causes binding of unintended types of probe DNA molecules, and the resulting DNA chip is defective. Accordingly, it is necessary to identify such a defect with reliability.

With the present embodiment, if a probe aqueous solution 210 reaches an adjacent probe holding unit 102, the probe aqueous solution 210 also inevitably reaches the inspection region 106. Accordingly, if it can be confirmed that the probe aqueous solution 210 has not reached the inspection region 106, it can be determined that an above-described defect resulting from cross-contamination has not occurred. Therefore, immediately after the step illustrated in FIG. 6B or immediately after the step illustrated in FIG. 6C, a defect resulting from cross-contamination can be detected by checking whether the inspection region 106 is wet or not. Alternatively, a defect resulting from cross-contamination may also be detected by checking whether there is an indication of drying after the probe aqueous solution 210 is once attached (e.g., salt residue) when the steps illustrated in FIGS. 6B and 6C are completed and a subsequent step is completed.

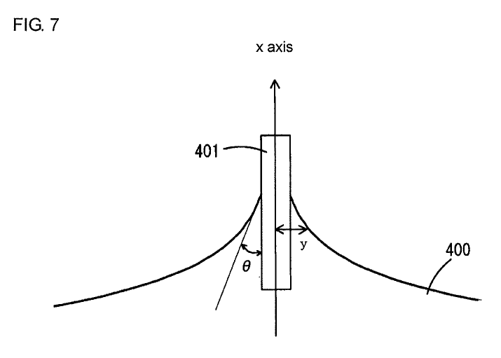

With the method illustrated in FIGS. 6A to 6C, the wetting force acting between the probe holding unit 102 of the probe-array substrate 100 and the probe aqueous solution 210 causes the probe aqueous solution 210 to be introduced and filled into the probe holding unit 102 of the probe-array substrate 100. Its mechanism of action is described below with reference to FIGS. 7 to 10.

FIG. 7 illustrates a state in which a solid cylinder 401 is inserted to the surface of a liquid 400 in the direction substantially perpendicular to the liquid surface. In FIG. 7, the x-axis is set along the central axis of the cylinder 401. When cross-sections are taken at every x coordinate, each of the surfaces of the liquid 400 has a substantially circular shape whose center is the x-axis.

When the radius of the circle is y, the surface area S of the surface of the liquid 400 can be represented by Equation 1 below.

$$\frac{d}{d x} ( \frac{2 π y \cdot {y}^{′}}{\sqrt{{y}^{′ 2} + 1}} ) = 2 π \cdot \sqrt{{y}^{′ 2} + 1} \\ 1 + {y}^{′ 2} - y \cdot {y}^{′} = 0. \qquad ( 3 )$$

The action of the surface tension makes the surface area of the liquid 400 a minimum. Liquid 400 has its source of supply, so there is no limitation to maintain the volume of the liquid 400 constant. Accordingly, the definite integral of expression 1 is at a stationary value with respect to a minute change in the function form of y. Hence, the differential equation is expressed by Equation 2 below (see pp. 13-20 of Akira Harashima, RIKIGAKU II-Analytical Dynamics, Shokabo, 21st Edition, Oct. 25, 1990).

$$\begin{matrix}S = {\int }_{{x}_{1}}^{{x}_{2}} 2 π y \cdot \sqrt{{( d x )}^{2} + {( d y )}^{2}} \\ = {\int }_{{x}_{1}}^{{x}_{2}} 2 π y \cdot \sqrt{{y}^{′ 2} + 1} \cdot d x\end{matrix} \qquad ( 1 )$$

When Equation 2 is rearranged, the following Equation 3 is obtained.

$$\frac{d}{d x} \frac{ y}{} , ( 2 π y \cdot \sqrt{{y}^{′ 2} + 1} ) = \frac{ y}{} ( 2 π y \cdot \sqrt{{y}^{′ 2} + 1} ) \qquad ( 2 )$$

Then, when the differential equation of Equation 3 is solved, the following Equation 4 is derived.

y=A·cosh {(x−B)/A} (4)

In Equation 4, A and B are constant values determined depending on the boundary conditions. For example, in the case of FIG. 7, the boundary condition is that the angle θ between the cylinder 401 and the liquid 400 is a natural wetting angle. Cosh is a hyperbolic cosine function and is defined by the following Equation 5.

Coshξ={exp ξ+exp (−ξ)}/2 (5)

In the case where the method illustrated in FIGS. 6A to 6C is used and the projection 103 of the probe holding unit 102 in the probe-array substrate 100 and the probe aqueous solution 210 are in contact with each other, as in the first physical step, the probe aqueous solution 210 is guided by the projection 103 to the hydrophilic region 105 of the probe holding unit 102. Because projection 103 is hydrophilic, the probe aqueous solution 210 moves on the guide grooves 109 and 112 (see FIG. 2) of the projection 103 and is guided to the hydrophilic region 105 by capillary action.

Even when the projection 103 has no guide groove, if the projection 103 is inserted deep into the opening of the nozzle 204 included in the silicon portion 203 of the supplying unit 200 and the tip of the silicon portion 203 and the hydrophilic region 105 of the probe holding unit 102 are brought sufficiently near to each other, the probe aqueous solution 210 reaches the hydrophilic region 105 of the probe holding unit 102. Accordingly, projection 103 need not necessarily have a guide groove. However, to facilitate guiding of the probe aqueous solution 210 to the hydrophilic region 105 of the probe holding unit 102 more reliably and smoothly, it is preferable that the projection 103 have a guide groove.

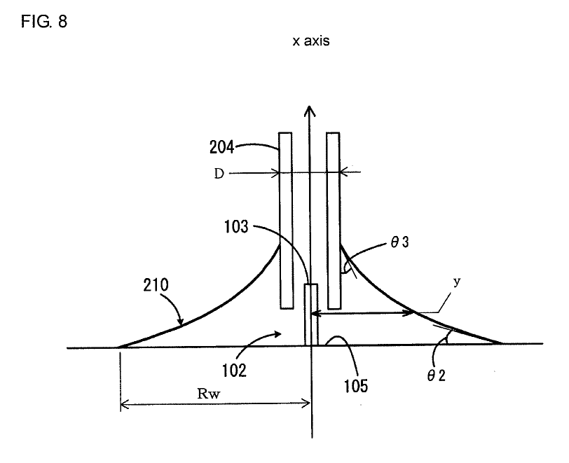

When the projection 103 guides the probe aqueous solution 210 to the hydrophilic region 105 of the probe holding unit 102, as described above, as the next step, it is preferable that the probe aqueous solution 210 sufficiently wet and spread out on the hydrophilic region 105 of the probe holding unit 102 and reach the inner edge of the hydrophobic region 104. The condition for carrying out this step is described below using FIG. 8.

In practice, the probe holding unit 102 has a finite size and is defined by the inner edge of the hydrophobic region 104. In the following discussion, a state is assumed where the probe holding unit 102 is large infinitely and the hydrophobic region 104 does not exist. Under these conditions, when the wetting spread amount Rw exceeds the hydrophilic region 105, in theory, the probe aqueous solution 210 covers the entire area of the hydrophilic region 105.

Also, Equation 4 described above is true between the radius y of the probe aqueous solution 210 in FIG. 8 and x. For the “tip of wetting” in the hydrophilic region 105 of the probe holding unit 102, the angle between the probe holding unit 102 and the probe aqueous solution 210 is a natural wetting angle θ2. For the “tip of wetting” on the outer surface of the nozzle 204, the angle between the outer surface of the nozzle 204 and the probe aqueous solution 210 is a natural wetting angle θ3. From these, when the wetting spread amount Rw of the probe aqueous solution 210 is calculated, the following Equation 6 is obtained.

Rw=[D×cosh {arcsinh (1/tan θ2)}]/[2×cosh {arcsinh (tan θ3)}] (6)

where D is the outer diameter of the nozzle 204 of the supplying unit 200. Accordingly, when the distance from the center of the projection 103 to the hydrophobic region 104 is I and the following Equation 7 is true, it can be said that the probe aqueous solution 210 covers the entire area of the hydrophilic region 105 of the probe holding unit 102.

I<[D×cosh {arcsinh (1/tan θ2)}]/[2×cosh {arcsinh (tan θ3)}] (7)

In practice, the probe aqueous solution 210 may wet and spread out more than the above calculation in such a way that the probe aqueous solution 210 moves into recesses of microscopic asperities of the hydrophilic region 105 of the probe holding unit 102. Accordingly, it is not necessarily said that if Equation 7 is not true, the probe aqueous solution 210 always does not cover some parts of the hydrophilic region 105. However, to reliably cover the entire area of the hydrophilic region 105 with the probe aqueous solution 210, it is preferable that Equation 7 be true.

Referring to the above-described example, the distance I from the center of the projection 103 to the hydrophobic region 104 is approximately 15 μm, the outer diameter D of the nozzle 204 of the supplying unit 200 is approximately 50 μm, and the wetting angles θ2 and θ3 between the silicon oxide film and water are approximately 4° to 20°. Although each of the wetting angles θ2 and θ3 has a value that varies depending on the cleanliness of the surface, the above range is general value of possible angles between the silicon oxide film and water.

The left-hand and right-hand sides of Equation 7 are calculated using the above values. The left-hand side is approximately 15 μm. Although varying depending on the values of θ2 and θ3, when considered in the range of approximately 4° to 20°, the right-hand side has a minimum value of approximately 68 μm at θ2=θ3=4° and has a maximum value of approximately 357 μm at θ2=θ3=20°. Accordingly, Equation 7 is true in either case. Hence, with the above-described specific example, the probe aqueous solution 210 can reliably cover the entire area of the hydrophilic region 105 of the probe holding unit 102.

When the length of the nozzle 204 in the silicon portion 203 of the supplying unit 200 is not sufficient, the probe aqueous solution 210 wetting the outer area of the nozzle 204 may reach the downward surface of the supplying unit 200 and the probe aqueous solutions 210 in the neighboring nozzles 204 may be mixed. To avoid mixture of the different probe aqueous solutions 210, it is necessary for each of the nozzles 204 to have a sufficiently long length. A preferable length of the nozzle 204 is discussed below.

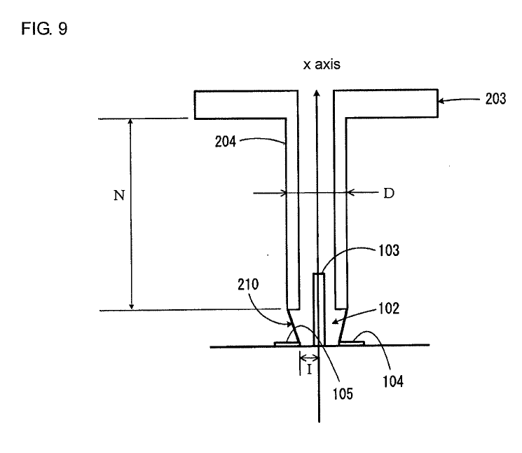

First, as illustrated in FIG. 9, when the outer diameter of the nozzle 204 is D and the distance from the center of the projection 103 to the hydrophobic region 104 is I, if I≦D/2, the probe aqueous solution 210 does not wet up on the outer area of the nozzle 204 regardless of the length N of the nozzle 204.

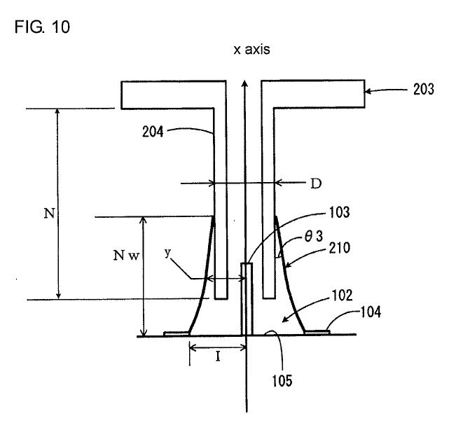

As illustrated in FIG. 10, if I>D/2, to find a preferable length of the nozzle 204, calculation of the wetting amount Nw illustrated in FIG. 10 is sufficient. Also in FIG. 10, between the radius y of the probe aqueous solution 210 and x, the above-described Equation 4 is true. At the “tip of wetting” on the outer area of the nozzle 204, the angle between the outer area of the nozzle 204 and the probe aqueous solution 210 is the natural wetting angle θ3. From these, when the wetting amount Nw is calculated, the following Equation 8 is obtained.

Nw=D×[arccosh {(2I/D)×cos h (ψ)}−ψ]/[2×cos h (ψ)] (8)

Here, ψ is defined by the following Equation 3 using θ3.

ψ=arcsinh (tan θ3) (9)

When the length of the nozzle 204 is N, N is longer than above-calculated Nw and the following Equation 10 is true, the wetting of the probe aqueous solution 210 can be stopped before the top of the nozzle 204.

N>D×[arccosh {(2I/D)×cosh (ψ)}−ψ]/[2×cosh (ψ)] (10)

Referring to the above-described specific example, the length N of the nozzle 204 is approximately 150 μm, the outer diameter D of the nozzle 204 is approximately 50 μm, the distance I from the center of the projection 103 to the hydrophobic region 104 is approximately 15 μm, and the wetting angle θ3 between the silicon oxide film is in the range of approximately 4° to 20°. It is determined using these values whether Equation 10 is true.

First, the left-hand side of Equation 10 is approximately 150 μm. Although varying depending on the value of θ3, when θ3 is considered in the range of approximately 4° to 20°, the right-hand side has a maximum value of approximately 28 μm at θ3=4° and has a minimum value of approximately 21 μm at θ3=20°. Accordingly, Equation 10 is true in either case. Hence, with the above-described specific example, the wetting of the probe aqueous solution 210 on the outer area of the nozzle 204 stops before the top of the nozzle 204. Thus, the possibility that the probe aqueous solution 210 wets the downward surface of the supplying unit 200 and the different probe aqueous solutions 210 are mixed is reduced.

The function “arccos h” is contained in Equations 9 and 10. This is the inverse function of the hyperbolic cosine function “cos h” defined in Equation 5. In theory, there are two inverse functions of the hyperbolic cosine function “cosh.” However, the inverse function defined by “arccosh” is a function that always takes zero or more as the function value. From the above definition, “arccosh” is uniquely determined.

When a supplying unit in which a plurality of nozzles are arranged, such as the illustrated supplying unit 200, is used, it is preferable that the wetting of the probe aqueous solution on the downward surface of the supplying unit be avoided because that wetting causes mixture of different probe aqueous solutions, and accordingly, it is preferable that Equation 10 be true. Even if a single nozzle is used, it is undesirable that the probe aqueous solution wet the part to be caught and operated be avoided. Therefore, it is preferable that Equation 10 be true and the length of the nozzle be sufficiently long with respect to the wetting amount of the probe aqueous solution.

If the outer area of the nozzle is hydrophobic, this is preferable in that the wetting by the probe aqueous solution is reduced. At this time, it is not necessary for the nozzle to be hydrophobic at the entire outer area. The advantage of reducing excessive wetting is obtainable as long as the tip and its adjacent area of the nozzle remain hydrophilic and at least base and its adjacent area of the nozzle are hydrophobic. One example of a method for making the outer area of the nozzle hydrophobic is a method of applying hydrophobic liquid.

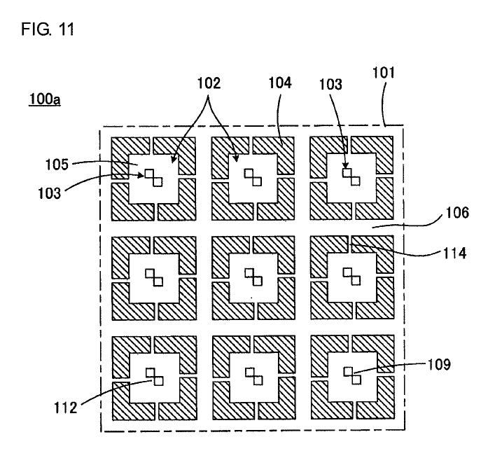

FIG. 11 is an illustration for use in describing a second embodiment of the present invention and corresponds to FIG. 2. In FIG. 11, similar reference numerals are used in the elements corresponding to those illustrated in FIG. 2, and the redundant description is omitted.

In a probe-array substrate 100a illustrated in FIG. 11, the hydrophilic region 105 forming a portion of the probe holding unit 102 and the inspection region 106 are coupled with a hydrophilic region 114 having a narrow width. The narrow hydrophilic region 114 is disposed therebetween and extends across the hydrophobic region 104. Even in this embodiment, if the width of the narrow hydrophilic region 114 is sufficiently small, a probe solution properly introduced in the probe holding unit 102 does not flow into the inspection region 106 through the narrow hydrophilic region 114. This is because when the probe solution is moving in the narrow hydrophilic region 114, if the width of the narrow hydrophilic region 114 is sufficiently narrow, the sum of an increase in surface free energy caused by the wetting in the hydrophobic region 104 at both sides of the narrow hydrophilic region 114 and an increase in surface-tension free energy caused by an increase in the surface area of the probe solution is larger than a decrease in surface free energy caused by the wetting on the surface of the narrow hydrophilic region 114.

The narrow hydrophilic region 114 does not offer a particularly advantageous operation and effect. However, the second embodiment has significance in confirming that the probe-array substrate including the narrow hydrophilic region 114 is within the scope of the present invention.

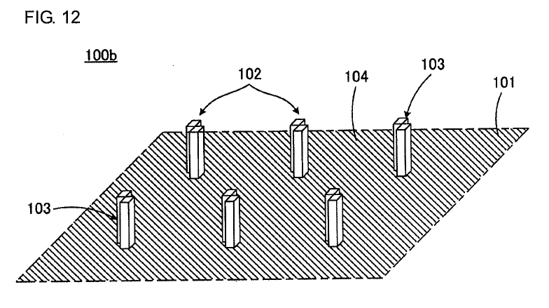

FIG. 12 is an illustration for use in describing a third embodiment of the present invention and corresponds to FIG. 1. In FIG. 12, the same or similar reference numerals are used in the elements corresponding to those illustrated in FIG. 1, and the redundant description is omitted.

In a probe-array substrate 100b illustrated in FIG. 12, the probe holding unit 102 is provided by the projection 103 alone. Accordingly, the hydrophobic region 104 is the portion other than the portion where the projection 103 on the main surface 101 of the probe-array substrate 100b. The projection 103 projects from the hydrophobic region 104.

To produce the probe-array substrate 100b through the steps illustrated in FIGS. 3A to 3C described above, after the projection 103 is formed on the material board 120, liquid resin is applied on the material board, a resin film is formed by spin coating, and then the resin film is cured. At this time, the thickness of the resin film formed on the top surface and the side surface of the projection 103 is smaller than the thickness of the resin film formed on the portion other than the projection 103. After that, the resin film formed on the top surface and the side surface of the projection 103 is substantially completely removed, and if plasma ashing is performed under the condition such that the resin film formed on the portion other than the projection 103 is not eliminated, the target probe-array substrate 100b is obtained.

With the above-described production method, the resin film to become the hydrophobic region 104 can be formed without use of photolithography. Accordingly, a lower cost production can be achieved, in comparison with the production of the previously described probe-array substrate 100. In addition, because the resin used is not necessarily photosensitive, the scope of selection of resin can be enhanced.

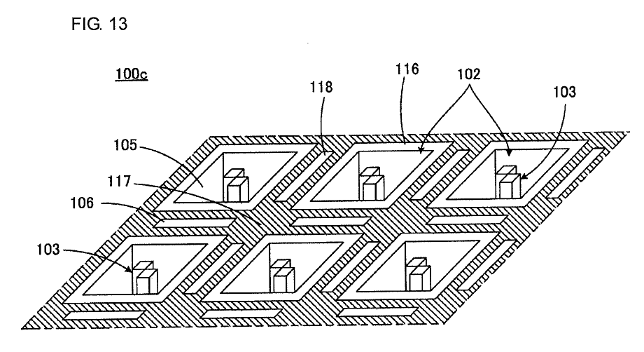

FIG. 13 is an illustration for use in describing a fourth embodiment of the present invention and corresponds to FIG. 1. In FIG. 13, the same or similar reference numerals are used in the elements corresponding to those illustrated in FIG. 1, and the redundant description is omitted.

For a probe-array substrate 100c illustrated in FIG. 13, a wall 116 is disposed so as to surround the projection 103 in each of the plurality of probe holding units 102. The height of the wall 116 is substantially the same as that of the projection 103. The groove section between the neighboring walls 116 is filled with a resin 117. The hydrophobic region 104 is provided by the surface of the resin 117 filled into the groove section. The inspection region 106 is provided by the top surface of a protrusive wall 118. The protrusive wall 118 forms an island at the groove section between the neighboring walls 116.

To produce the probe-array substrate 100c through the steps similar to those illustrated in FIGS. 3A to 3C described above, the projection 103, the wall 116, and the protrusive wall 118 are simultaneously formed. A liquid resin is poured between the neighboring walls 116, and the liquid resin is cured. Then, the resin attached on the portion other than the groove section between the neighboring walls 116 and on the top surface of the protrusive wall 118 is removed by, for example, plasma ashing performed such that the resin 117 filled between the neighboring walls 116 is not eliminated. When the material board to which such processing is to be performed is made of silicon, the above-described plasma ashing produces an oxide film on its uppermost surface.

When the above-described probe-array substrate 100c is used, a larger amount of probe solution can be retained in the probe holding unit 102 in comparison with when the previously described probe-array substrate 100 is used because the probe holding unit 102 is provided with a recessed shape. Because a relatively large amount of probe solution can be spotted, it is easy to control the amount of the probe solution to be spotted, and it is easy to reduce unevenness of the amount of the probe solution spotted.

When the above-described probe-array substrate 100c is used, the wall 116 can block the probe solution from spreading even if a slightly excessive amount of a probe solution is spotted. Accordingly, the amount of the probe solution to be spotted can be set larger. This also contributes to facilitation of control on the amount of the probe solution to be spotted and reduction in unevenness of the probe solution spotted.

In addition, when the above-described probe-array substrate 100c is used, probe molecules can be retained on its side surface because the probe holding unit 102 is provided by a recessed shape. Accordingly, the number of probe molecules retainable in the probe holding unit 102, i.e., the number of probe molecules retained in a spot, can be increased, so the sensitivity of the probe array can be enhanced.

As a modification example of the probe-array substrate 100c illustrated in FIG. 13, a probe-array substrate that does not include the protrusive wall 118 providing the inspection region 106 and has a shorter distance between neighboring walls 116 can be used. In this case, the size of the probe-array substrate can be reduced.

While preferred embodiments of the invention have been described above, it is to be understood that variations and modifications will be apparent to those skilled in the art without departing from the scope and spirit of the invention. The scope of the invention, therefore, is to be determined solely by the following claims.

What is claimed is:

1. A probe-array substrate comprising:
a main surface;
a plurality of probe holding units each comprising a high wettability region arranged on the main surface, the high wettability region exhibiting a relatively high wettability with respect to a probe solution, as indicated by a contact angle therewith of 90° or less; and
a low wettability region disposed so as to surround each of the plurality of probe holding units,
wherein the low wettability region exhibits a relatively low wettability with respect to a probe solution, as indicated by a contact angle therewith of more than 90°.

2. The probe-array substrate according to claim 1, wherein the region exhibiting a relatively high wettability comprises a projection.

3. The probe-array substrate according to claim 2, wherein the projections project from the low wettability region, and the probe holding units consist of the projections.

4. The probe-array substrate according to claim 2, wherein a probe holding unit comprises the projection and a high wettability region disposed around the projection on the main surface.

5. The probe-array substrate according to claim 4, wherein a probe holding unit is disposed in a recessed section of the main surface.

6. The probe-array substrate according to claim 5, further comprising an inspection region exhibiting a relatively high wettability with respect to each of a number of predetermined probe solutions,
wherein a low wettability region is disposed between the inspection region and each of neighboring probe holding units of the plurality of probe holding units.

7. The probe-array substrate according to claim 6, wherein the projection comprises a guide groove for facilitating an introduction of a probe solution into the probe holding unit.

8. The probe-array substrate according to claim 7, wherein the probe solution is an aqueous solution,
the main surface is hydrophilic, and
the low wettability region is a cured photosensitive resin film on the main surface.

9. The probe-array substrate according to claim 8, wherein
the probe holding unit is disposed in a portion of the main surface from which the resin film is absent.

10. The probe-array substrate according to claim 4, wherein each of the plurality of probe holding units includes a wall surrounding the projection, and
a resin-coated groove section disposed between neighboring walls of the walls,
wherein the grove section comprises a low wettability region and a high wettability region on its surface.

11. The probe-array substrate according to claim 4, further comprising an inspection region exhibiting a relatively high wettability with respect to each of a number of predetermined probe solutions,
wherein a low wettability region is disposed between the inspection region and each of neighboring probe holding units of the plurality of probe holding units.

12. The probe-array substrate according to claim 3, wherein a probe holding unit is disposed in a recessed section of the main surface.

13. The probe-array substrate according to claim 12, further comprising an inspection region exhibiting a relatively high wettability with respect to each of a number of predetermined probe solutions,
wherein a low wettability region is disposed between the inspection region and each of neighboring probe holding units of the plurality of probe holding units.

14. The probe-array substrate according to claim 2, wherein a probe holding unit is disposed in a recessed section of the main surface.

15. The probe-array substrate according to claim 14, further comprising an inspection region exhibiting a relatively high wettability with respect to each of a number of predetermined probe solutions,
wherein a low wettability region is disposed between the inspection region and each of neighboring probe holding units of the plurality of probe holding units.

16. A probe array comprising:
a probe-array substrate according to claim 1; and
a probe molecule in a plurality of probe holding units of the probe-array substrate.

17. A method of producing a probe array, the method comprising:
providing a probe-array substrate according to claim 1;
providing a supplying unit that has nozzles arranged so as to correspond to the projections, a plurality of the nozzles having a probe solution therein; and
positioning the nozzles of the supplying unit sufficiently near to the corresponding projection to cause the probe solution and the projection to come into contact with each other, and thus guiding the probe solution into the probe holding unit.

18. The method of producing a probe array according to claim 17, wherein I≦D/2, where I is a distance from a center of each of the projections to the low wettability region and D is an outer diameter of each of the nozzles.

19. The method of producing a probe array according to claim 18, wherein N>D×[arccosh {(2I/D)×cosh (ψ)}−ψ]/[2×cosh (ψ)]wherein N is the length of the nozzle, and ψ=arcsinh (θ3), where θ3 is a wetting angle between an outer area of the nozzle and the probe solution.

20. A method of producing a probe array, the method comprising:
providing a probe-array substrate according to claim 4;
providing a supplying unit that has nozzles arranged so as to correspond to the projections, each of the nozzles having a probe solution therein; and
bringing the nozzles of the supplying unit sufficiently near to the corresponding projections to cause the probe solution and the projection to come into contact with each other, and thus guiding the probe solution into the probe holding unit,
wherein I<[D×cosh {arcsinh (1/tan θ2)}]/[2×cosh {arcsinh (tan θ3)}],
where D is an outer diameter of the nozzle, I is a distance from a center of the projection to the low wettability region, θ2 is a wetting angle between the high wettability region adjacent to the probe holding unit in the probe-array substrate, and θ3 is a wetting angle between an outer area of the nozzle and the probe solution.

21. A method of producing a probe array, the method comprising:
providing a probe-array substrate according to claim 6;
providing a supplying unit that has nozzles arranged so as to correspond to the projections, each of the nozzles containing a probe solution;
bringing the nozzle of the supplying unit sufficiently near to the corresponding projection to cause the probe solution and the projection to come into contact with each other, and thus guiding the probe solution into the probe holding unit; and
separating the nozzle and probe solution;
wherein the sequence of providing and positioning and separating steps with a new probe-array substrate in each sequence is repeated until the sequence in which the inspection region contains neither probe solution or dried probe solution is complete.
